(19) United States
(12) Patent Application Publication
(10) Pub. No.: US 2017/0161359 A1
(43) Pub. Date: Jun. 8, 2017

(54) PATTERN-DRIVEN DATA GENERATOR

(71) Applicant: SAP SE, Walldorf (DE)

(72) Inventors: Uwe W. Bloching, Nussloch (DE); Stefan Rau, Hielheim (DE)

(21) Appl. No.: 14/961,024

(22) Filed: Dec. 7, 2015

(51) Int. Cl. G06F 17/30

(52) U.S. Cl. CPC G06F 17/30604; G06F 17/30339

(57) ABSTRACT

The present disclosure involves systems, software, and computer implemented methods for generating data. An example method includes identifying a data model that describes one or more data entities. The data model is evaluated to determine a set of entity dependencies between entities. A set of rules is identified for a data generation scenario for generation of data for the one or more data entities. The set of rules includes one or more attribute rules each describing how data for one or more data attributes is to be generated. A set of workload portions is determined. Data is generated according to the set of attribute rules and the entity dependencies, including creating a data generation task for each determined workload portion. Data generated from each data generation task is stored in one or more data targets.

### TECHNICAL FIELD

The present disclosure relates to computer-implemented methods, software, and systems for generating data.

### BACKGROUND

Test data can be used for testing of a software system. For example, during development of the software system, test data can be generated and can be used during test execution of the software system. The test data can be used to test whether the software system produces expected outputs. The test data can also be used during demonstration of the software system.

### SUMMARY

The present disclosure involves systems, software, and computer implemented methods for generating data. An example method includes identifying a data model that describes one or more data entities. The data model is evaluated to determine a set of entity dependencies between entities. A set of rules is identified for a data generation scenario for generation of data for the one or more data entities. The set of rules includes one or more attribute rules each describing how data for one or more data attributes is to be generated. A set of workload portions is determined. Data is generated according to the set of attribute rules and the entity dependencies, including creating a data generation task for each determined workload portion. Data generated from each data generation task is stored in one or more data targets.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for generating data.

FIG. 2 illustrates an example data entity graph.

FIG. 3 is a diagram that illustrates example rule types and relationships between the rule types.

FIG. 4 is a flowchart of an example method for generating data.

FIG. 5 is a sequence diagram of an example method for generating data.

FIG. 6 is a sequence diagram of an example method for workload calculation.

FIG. 7 is a flowchart of an example method illustrating state transitions for a node.

FIG. 8 is a flowchart of an example method illustrating state values and state transition for an attribute rule.

FIG. 9 is a flowchart of an example method for generating data for an entity.

FIG. 10 is a flowchart of an example method for preparing task processing for a header node.

FIG. 11 is a flowchart of an example method for preparing task processing for a child node.

FIG. 12 is a flowchart of an example method for generating data for a header node.

FIG. 13 is a flowchart of an example method for generating data for a child node.

### DETAILED DESCRIPTION

A software development team can have a need for data, such as to test or demonstrate a software system or perform analytics. The team may not want to or may not be allowed to use customer or other data that has been previously used in a production system. The team may not have permission to use customer data, for example. As another example, customer data may not be in a form that is desired by the software development team. The software development team may want data, in large quantities, that follows particular patterns, or rules. For example, the software development team may want to ensure that the data supports a comprehensive test plan developed for the software system. A data generator system can be used by the software development team to automatically generate data that follows patterns specified by the team. The data generator system can dynamically and automatically generate large amounts of data in a small amount of time. The generated data can meet current, desired patterns of data for use in meeting current testing, demonstration, or analysis needs (e.g., unlike static data which may not meet desired patterns). Generated data can be free of copyright concerns. The amount of data to be generated and the characteristics of patterns of generated data can be controlled by parameters which are passed to a data generator.

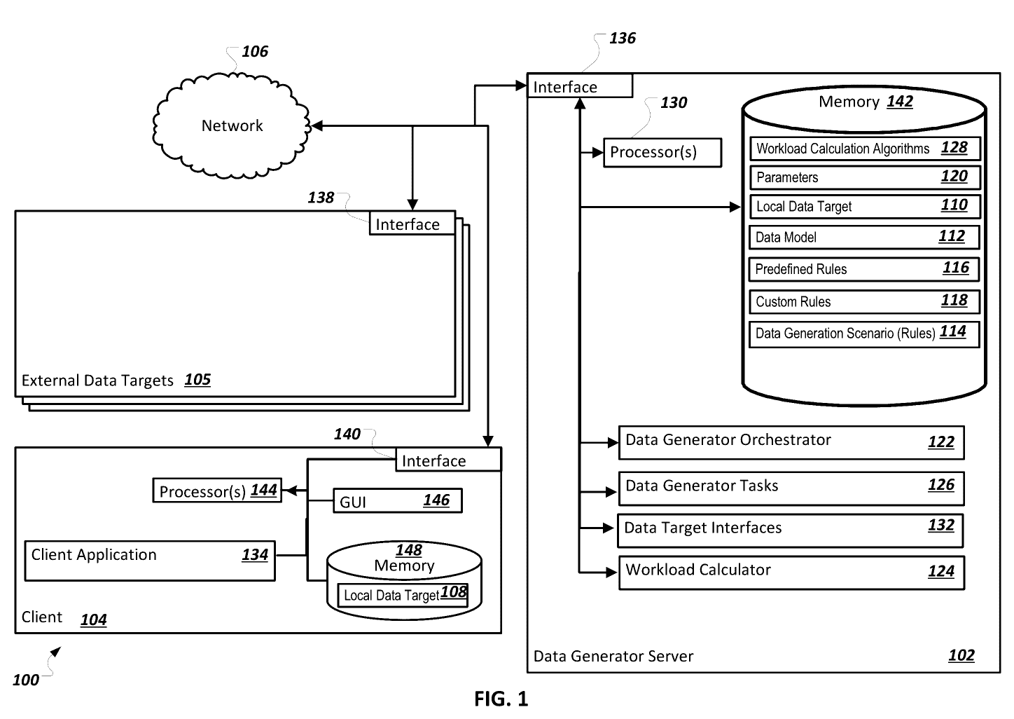

FIG. 1 is a block diagram illustrating an example system 100 for generating data. Specifically, the illustrated system 100 includes or is communicably coupled with a data generator server 102, a client device 104, one or more external data targets 105, and a network 106. Although shown separately, in some implementations, functionality of two or more systems or servers may be provided by a single system or server. In some implementations, the functionality of one illustrated system or server may be provided by multiple systems or servers. For example, multiple data generator servers 102 may be used. In some implementations, one data generator server 102 coordinates data generation tasks performed on other data generator servers 102.

A user associated with the client device 104 can initiate a process to generate data to be stored into one or more data targets. For example, generated data can be stored in the one or more external targets 105, a local data target 108 local to the client device 104, and/or a local data target 110 local to the data generator server 102.

A data model 112, which describes the data to be generated, can be generated and/or provided to the data generator server 102. The data model 112 defines entities, nodes (e.g., tables) and attributes (e.g., columns). An entity can be associated with one or more semantically related tables. A table can be associated with one or more data attributes. The data model 112 can define relationships, including dependencies, between entities and between tables.

The data to be generated can be described in a data generation scenario 114. The data generation scenario 114 is a collection of rules, including, for example, attribute rules, which describe a pattern or distribution of data for one or more attributes; node rules, which are a collection of attribute rules; entity rules, which are a collection of node rules; property rules, which describe how much data to create for a node; and data target rules, which specify which data target(s) to use. As an example, an attribute rule can be used to generate data for a gender column so that the gender values are 60% male and 40% female. As another example, an attribute rule can be used to generate data for a customer age column so that the age values are in a uniform distribution of values in a range between 18 and 70 years.

The data generation scenario 114 can refer to one or more predefined (e.g., reusable) rules 116. Some or all of the predefined rules 116 may have been used for other data generation scenarios. The data generation scenario 114 can refer to one or more custom rules 118 which have been defined for use in the data generation scenario 114 and which have not been used for other data generation scenarios. Some or all of the custom rules 118 can be configured to be reused in future data generation scenarios. A new rule can be added to the predefined rules 116 or the custom rules 118 by generating the new rule to comply with an expected framework interface provided by the data generator server 102.

Some or all of the predefined rules 116 and the custom rules 118 can be configured to accept one or more parameters 120. The parameters 120 can be provided, for example, by the client device 104 or can be configured by an administrator of the data generator server 102. The parameters 120 can be provided to an orchestrator 122. Some rules can have default, or implied, parameters.

The orchestrator 122 can orchestrate the data generation process. The orchestrator 122 can send a request to a workload calculator 124 to calculate workload portions to be distributed among one or more data generation tasks 126. The workload calculator 124 can identify a set of workload calculation algorithms 128 that can be used to generate data for the data generation scenario 114. In some implementations, the workload calculator 124 can identify a set of available resources (such as processors 130, other servers or systems which can be used for data generation, number of available worker processes in the data generator server 102, etc.).

The workload calculator 124 can select one or more workload calculation algorithms 128 based on the available resources. For example, suppose that the data generation scenario 114 relates to generating sensor data for a set of sensors for a certain number of days. When more than a threshold number of processors 130 are available, the workload calculator 124 can select a workload calculator algorithm 128 that defines a workload portion as generating one hour's worth of sensor data for one sensor. As another example, when less than the threshold number of processors 130 are available, the workload calculator 124 can select a workload calculator algorithm 128 that defines a workload portion as generating one day's worth of sensor data for one sensor. The workload calculation algorithms 128 can be included in or otherwise associated with the data generation scenario 114.

Once a workload calculation algorithm 128 has been selected and corresponding workload portions have been determined, the orchestrator 122 can assign each workload portion to a different data generator task 126. The data generation tasks 126 generate data according to the rules specified in the data generation scenario 114 and according to the selected workload calculation algorithm 128. A respective data generation task 126 can each notify the orchestrator 122 when the respective data generation task 126 has completed.

When a particular data generation task 126 has completed generation of data to be generated by the data generation task 126, the data generation task 126 can initiate transfer of data to one or more of the data target(s) specified in the data target rules included in the data generation scenario 114. For example, when the data target rules include a reference to an external data target 105, the data generator server 102 can transfer data to the external data target 105 using one or more data target interfaces 132.

The orchestrator 122 can provide status regarding the data generation process. For example, status can be provided to the client device 104 and displayed in a client application 134. The status information can include statistics about generated data and information about any errors or conditions which may have occurred during data generation.

As used in the present disclosure, the term “computer” is intended to encompass any suitable processing device. For example, although FIG. 1 illustrates a single data generator server 102 and a single client device 104, the system 100 can be implemented using a single, stand-alone computing device, two or more data generator servers 102 or two or more clients 104. Indeed, the data generator server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the data generator server 102 and the client device 104 may be adapted to execute any operating system, including Linux, UNIX, Windows, Mac OS®, Java™, Android™, iOS or any other suitable operating system. According to one implementation, the data generator server 102 may also include or be communicably coupled with an e-mail server, a Web server, a caching server, a streaming data server, and/or other suitable server.

Interfaces 136, 138, and 140 are used by the data generator server 102, the one or more external data targets 105, and the client device 104, respectively, for communicating with other systems in a distributed environment—including within the system 100—connected to the network 106. Generally, the interfaces 136, 138, and 140 each comprise logic encoded in software and/or hardware in a suitable combination and operable to communicate with the network 106. More specifically, the interfaces 136, 138, and 140 may each comprise software supporting one or more communication protocols associated with communications such that the network 106 or interface's hardware is operable to communicate physical signals within and outside of the illustrated system 100.

The data generator server 102 includes one or more processors 130. Each processor 130 may be a central processing unit (CPU), a blade, an application specific integrated circuit (ASIC), a field-programmable gate array (FPGA), or another suitable component. Generally, each processor 130 executes instructions and manipulates data to perform the operations of the data generator server 102. Specifically, each processor 130 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The data generator server 102 includes memory 142. In some implementations, the data generator server 102 includes multiple memories. The memory 142 may include any type of memory or database module and may take the form of volatile and/or non-volatile memory including, without limitation, magnetic media, optical media, random access memory (RAM), read-only memory (ROM), removable media, or any other suitable local or remote memory component. The memory 142 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the data generator server 102.

The client device 104 may generally be any computing device operable to connect to or communicate with the data generator server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the client application 134. A client application is any type of application that allows the client device 104 to request and view content on the client device 104. In some implementations, a client application can use parameters, metadata, and other information received at launch to access a particular set of data from the data generator server 102. In some instances, a client application may be an agent or client-side version of the one or more enterprise applications running on an enterprise server (not shown).

The client device 104 further includes one or more processors 144. Each processor 144 included in the client device 104 may be a central processing unit (CPU), an application specific integrated circuit (ASIC), a field-programmable gate array (FPGA), or another suitable component. Generally, each processor 144 included in the client device 104 executes instructions and manipulates data to perform the operations of the client device 104. Specifically, each processor 144 included in the client device 104 executes the functionality required to send requests to the data generator server 102 and to receive and process responses from the data generator server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or a graphical user interface (GUI) 146.

The GUI 146 of the client device 104 interfaces with at least a portion of the system 100 for any suitable purpose, including generating a visual representation of the client application 134. In particular, the GUI 146 may be used to view and navigate various Web pages. Generally, the GUI 146 provides the user with an efficient and user-friendly presentation of business data provided by or communicated within the system. The GUI 146 may comprise a plurality of customizable frames or views having interactive fields, pull-down lists, and buttons operated by the user. The GUI 146 contemplates any suitable graphical user interface, such as a combination of a generic web browser, intelligent engine, and command line interface (CLI) that processes information and efficiently presents the results to the user visually.

Memory 148 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including user selections, caches, classes, frameworks, applications, backup data, business objects, jobs, web pages, web page templates, database tables, parameters, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the data generator server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

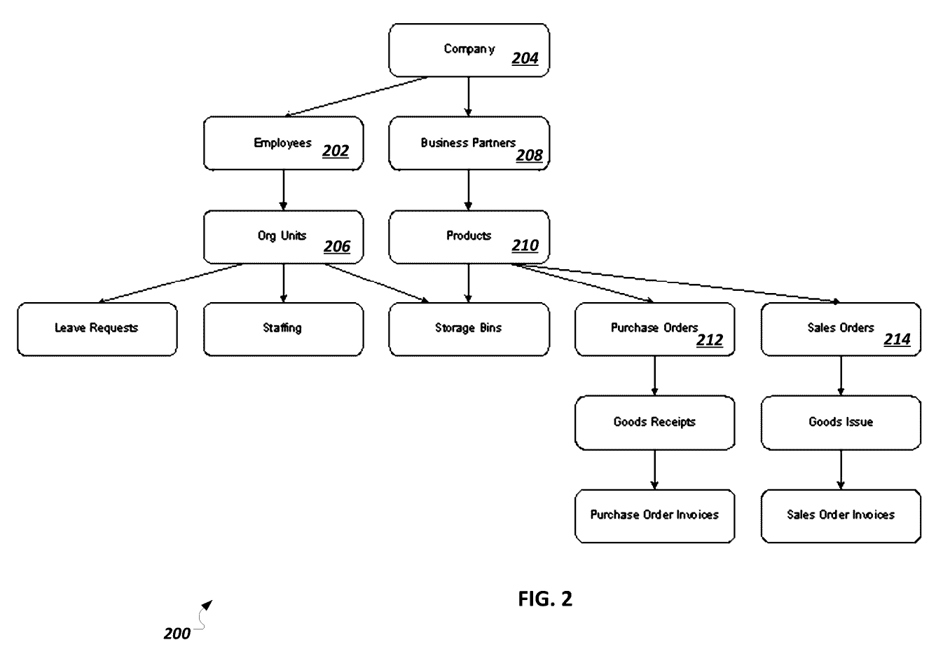

FIG. 2 illustrates an example data entity graph 200. The data entity graph 200 can be included in or otherwise associated with the data model 112, for example. When generating data, dependencies between entities can be evaluated. The arrows on the entity graph 200 represent dependencies between entities. For example, an Employees entity 202 is dependent on a Company entity 204, and an Org Units entity 206 is dependent on the Employees entity 202. Data for a dependent entity can be generated after data for the depended-upon entity has been generated. For example, data for the Employees entity 202 can be generated when data for the Company entity 204 is available, and data for the Org Units entity 206 can be generated when data for the Employees entity 202 is available.

The data entity graph 200 can illustrate dependencies between master and transactional data, for example. For example, the Company entity 204, a Business Partners entity 208, and a Products entity 210 can be considered master data entities and a Purchase Orders entity 212 and a Sales Orders entity 214 can be considered transactional data entities. When data is generated, data for master data entities can be generated before data for transactional data entities.

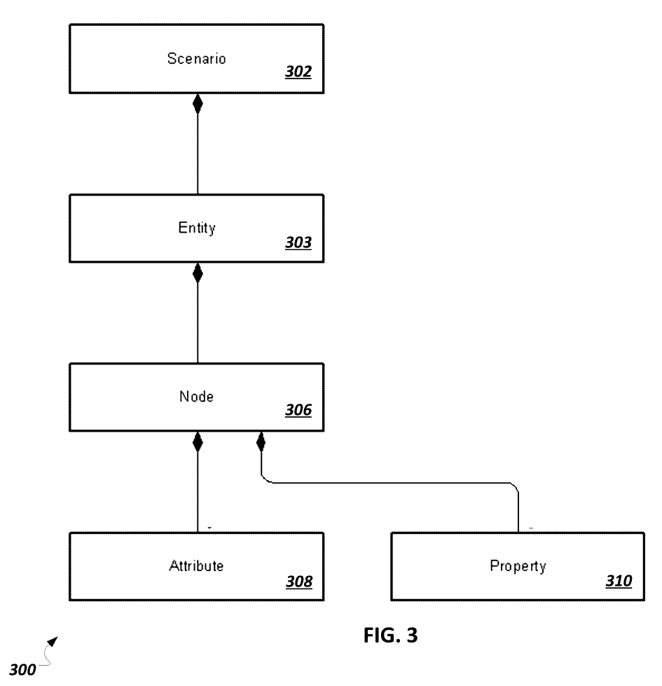

FIG. 3 is a diagram 300 that illustrates example rule types and relationships between the rule types. A scenario 302 represents a collection of rules. The scenario 302 can be associated with one or more entity rules 303. An entity rule 303 can be associated with one or more node rules 306 (e.g., an entity rule 303 represents a collection of node rules 306 for a given entity). An entity rule 303 can be a collection of semantically-related node rules 306, for example. An entity rule 303 can register and trigger data generation for associated node rules 306.

A node rule 306 can be associated with one or more attribute rules 308 (e.g., a node rule 306 represents a collection of attribute rules 308 for a particular node (e.g., table)). A node rule 306 can register and trigger data generation for associated attribute rules 308. A node rule 306 can include or be otherwise associated with a data base table buffer into which the associated attribute rules 308 generate data.

A node rule 306 can be associated with a header node, a child node, or an extension node or any other kind of node. A header node represents a top-level database table for an entity. For example, a Sales Order entity can include a Sales Order Header Table node. A header node has no parent node. A child node is a node which has a parent node (the parent node of a child node can be a header node or can be another child node). An extension node can be used to store additional information associated with a header or child node. An extension node has a same primary key as the associated header or child node.

An attribute rule 308 can be used to generate data for one or more attributes (e.g., columns) in a node. An attribute rule can be a single-attribute rule, a tuple-attribute-rule, or a key-creation attribute rule, or a preparation attribute rule. A single-attribute rule can be used to generate data into a single database column. For example, a single-attribute rule can populate a customer age column. A tuple attribute rule can be used to generate data into a set of two or more related columns. For example, an attribute-tuple rule can be used to populate name information, with the name information being stored in first name, last name, and title columns. A key-creation attribute rule can be used for creating values for primary key columns. Key-creation attribute rules and preparation attribute rules can be processed before other attribute rules.

An attribute rule 308 can be used to generate data for one or more columns according to a particular pattern. In other words, an attribute rule 308 can be used to generate data that conforms to a particular distribution of values within the column. An attribute rule 308 can include logic to generate data according to the desired pattern. For example, an attribute rule 308 can describe how to generate a uniform distribution for a customer age column. An attribute rule 308 can be associated with one or more parameters. For example, upper and lower age limits can be specified for the customer age column.

In further detail, attribute rules 308 can be grouped into categories, such as key-related rules, constant rules, iteration rules, uniform, random, or statistical distribution rules, condition-based rules, and data provider based rules. Key-related rules can include rules relating to creating GUIDs (Globally Unique Identifiers, e.g., as keys for header nodes), keys with values that occur within a defined range (e.g., for readable, unique, primary keys). Preparation attribute rules can include rules relating to managing key duplication (e.g., populating foreign key fields based on related primary key values, such as from a parent node to a child node), and creating unique secondary keys. A constant rule can be used to fill a column with a same, constant value, such as to initialize the data within the column.

A number iteration rule can be used to fill a column with values that increase in size, given a starting value and a step rate. A set iteration rule can be used to fill a column with values from a set of values, with values in the set repeating (e.g., country codes). The values can be randomly or evenly distributed. A number range iteration rule can be used to fill a column with number values from a given range (e.g., for populating a readable, unique, secondary key column). Other number value rules, such as for integer or decimal values, can be used to fill a column with random or distributed values within a specified range. For example, a decimal value rule can be used to fill a column with example sales totals. Date value rules can be used to generate date values in either a random or uniform distribution.

Statistical rules can be used to generate values according to a normal, Poisson, percentage-based, or some other type of distribution. A condition-based rule can be used to fill a column with values that depend upon a condition. For example, the value for a column for a particular row may depend on the value of another column in that row. A data provider rule can be used to populate a column using data received from an external data provider. A data provider can, for example, provide addresses, cities, streets, telephone numbers, names, or email addresses that conform to values, patterns, or formats used in a particular country or region.

An attribute rule can use a value calculator to generate data. A value calculator represents a reusable algorithm to create a scalar value (e.g., integer, character string, date). A value calculator can accept one or more parameters. The same value calculator can be used by multiple attribute rules. For example, multiple attribute rules can use a same value calculator that calculates a random integer.

A node rule 306 can be associated with one or more property rules 310. A property rule 310 can describe how many node elements are to be created during data generation. The number of node elements to create can be specified as a constant value or can be determined by an algorithm. Property rules 310 can be used in workload calculation (described in more detail below). Property rules 310 can be used to determine a size of generated tables.

The scenario 302, the entity 303, and/or the node 306 can be associated with one or more data target rules (not shown). A data target rule can specify a data target into which generated data is to be stored. A data target can represent a database, a file, an external data service, or some other type of data persistence.

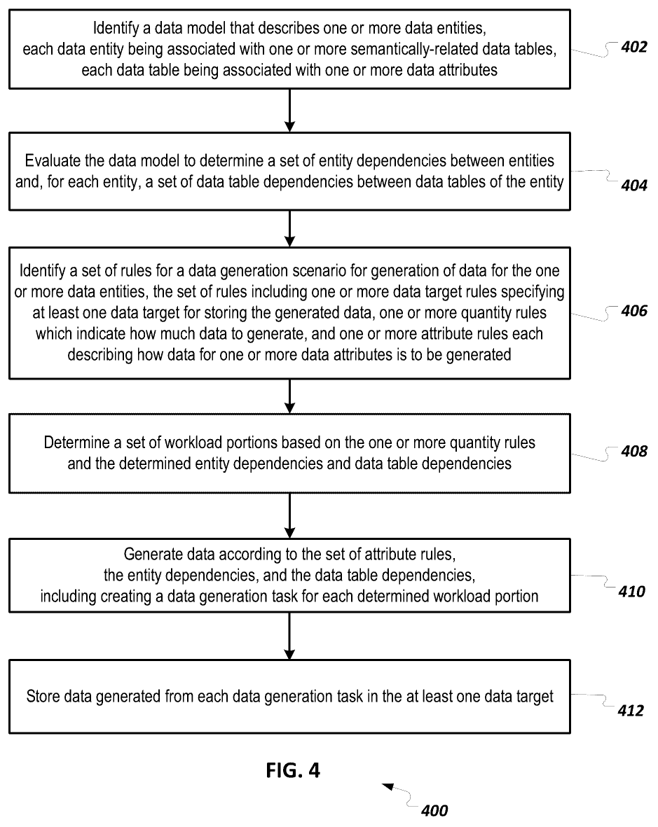

FIG. 4 is a flowchart of an example method 400 for generating data. It will be understood that method 400 and related methods may be performed, for example, by any suitable system, environment, software, and hardware, or a combination of systems, environments, software, and hardware, as appropriate. For example, one or more of a client, a server, or other computing device can be used to execute method 400 and related methods and obtain any data from the memory of a client, the server, or the other computing device. In some implementations, the method 400 and related methods are executed by one or more components of the system 100 described above with respect to FIG. 1. For example, the method 400 and related methods can be executed by the data generator server 102 of FIG. 1.

At 402, a data model is identified that describes one or more data entities, each data entity being associated with one or more semantically-related data tables, where each data table is associated with one or more data attributes. At 404, the data model is evaluated to determine a set of entity dependencies between entities, and, for each entity, a set of data table dependencies between data tables of the entity.

At 406, a set of rules is identified for a data generation scenario for generation of data for the one or more data entities, the set of rules including one or more data target rules specifying at least one data target for storing the generated data, one or more quantity (e.g., property) rules which indicate how much data to generate, and one or more attribute rules each describing how data for one or more data attributes is to be generated. One or more parameters can be received for some or all of the rules. Identifying the set of rules can include identifying at least one predetermined rule used previously used for at least one other data generation scenario. As another example, identifying the set of rules can include generating at least one new rule that has not been previously used for another data generation scenario.

At 408, a set of workload portions is determined based on the one or more quantity rules and the determined entity dependencies and data table dependencies. Determining the set of workload portions can include determining whether data corresponding to one or more rules already exists in a data target. Determining the set of workload portions can include identifying at least two candidate workload calculation algorithms, identifying a set of resources (e.g., processors, processes, systems) available for data generation, selecting a particular candidate workload calculation algorithm based on the available resources, and determining the set of workload portions based on the selected workload calculation algorithm.

At 410, data is generated according to the set of attribute rules, the entity dependencies, and the data table dependencies, including the creation of a data generation task for each determined workload portion. Generating data can include generating data for a first entity that is dependent on a second entity, where the data for the first entity is generated after data for the second entity has already been generated. The first entity can include transactional data and the second entity can include master data, for example. Generating data can include generating data for a parent data table before generating data for a child data table that is associated with the parent data table. Generating data can include generating data for a first attribute that is dependent upon a second attribute after generating data for the second attribute. The first and second attributes can be associated with a same table or each with different tables.

At 412, data generated from each data generation task is stored in the at least one data target. The data target can be an external or local data target. For example, the data target can be a database or a file.

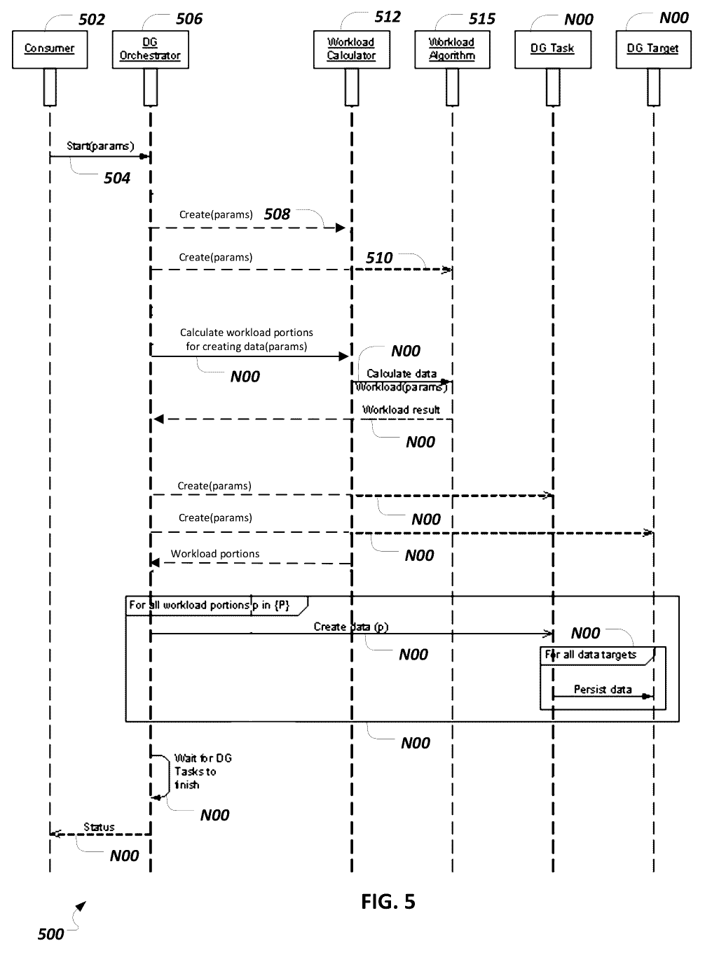

FIG. 5 is a sequence diagram of an example method 500 for generating data. It will be understood that method 500 and related methods may be performed, for example, by any suitable system, environment, software, and hardware, or a combination of systems, environments, software, and hardware, as appropriate. For example, one or more of a client, a server, or other computing device can be used to execute method 500 and related methods and obtain any data from the memory of a client, the server, or the other computing device. In some implementations, the method 500 and related methods are executed by one or more components of the system 100 described above with respect to FIG. 1.

A consumer (e.g., user) 502 sends a request 504 to a data generation (DG) orchestrator 506 to start a data generation process. The request 504 can include one or more parameters for data generation. The orchestrator 506 sends requests 508 and 510 to initialize a workload calculator component 512 and a workload algorithm component 514, respectively. The requests 508 and 510 may include the parameters received in the request 504.

The orchestrator 506 sends a request 516 to the workload calculator component 512 to calculate workload portions for the generation of data. The workload calculator component 512 can evaluate and select a particular workload algorithm. In some implementations, the received parameters can indicate a workload algorithm to use. The workload calculator component 512 sends a request 518 to the workload algorithm component 514 to calculate workload portions based on the selected workload algorithm. The workload algorithm component 514 can send information 520 which indicates a number of workload portions to the orchestrator 506 (and/or to the workload calculator component 512).

The orchestrator 506, in response to receiving the information 520, can send a message 522 to a data generation task component 524 to configure a set of data generation tasks that include a total number of data generation tasks equal to the number of workload portions, with each data generation task assigned to generate data for a particular workload portion. The orchestrator 506 can send a message 526 to a data target component 528 to initialize one or more data targets into which generated data is to be stored.

The orchestrator 506 can receive workload portion information 529 from the workload calculator component 512 (and/or from the workload algorithm component 514). The orchestrator 506 can, as illustrated by a repetition structure 530, for each workload portion, send a message 532 to a particular data generation task to request generation of data for the workload portion associated with the task. The message 532 can include a portion of a rule tree that corresponds to the particular data generation task. The rule tree portion can be passed from the orchestrator 506 to the particular data generation task and can be represented as a XML (eXtensible Markup Language) stream which includes a serialized representation of the rule tree portion. The data generator task can de-serialize the XML stream to instantiate a rule tree that includes the rule tree portion. The rule tree can be represented in other formats other than XML. The orchestrator 506 can, for example, serialize the rule tree into stream of another type of format and a given data generator task can deserialize the stream.

The data generation tasks can run in parallel. Each data generation task can persist data into a data target (e.g., as illustrated by an arrow 534). The orchestrator 506 can wait for and receive notification of each data generation task completion (e.g., as illustrated by an arrow 536). When all data generation tasks have completed, the orchestrator 506 can provide status 538 to the consumer 502 (e.g., about amount of generated data and success or failure of data generation).

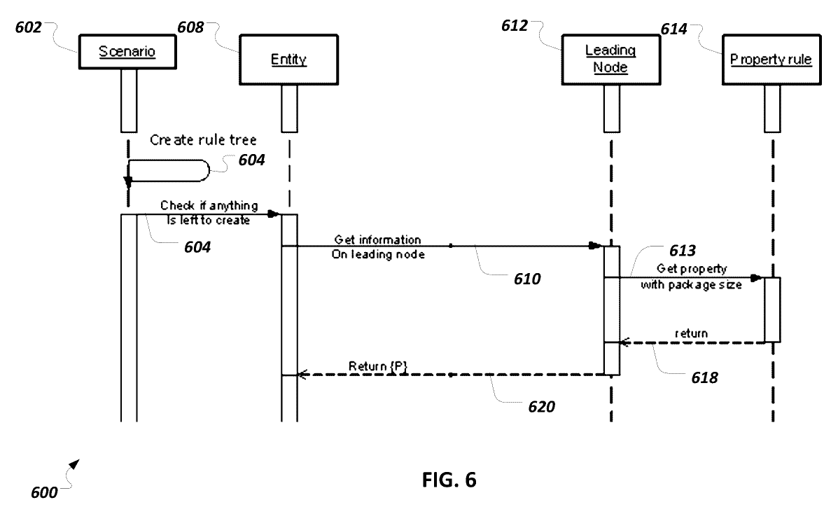

FIG. 6 is a sequence diagram of an example method 600 for workload calculation. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1.

At 602, a scenario object 604 initiates creation of a rule tree. The rule tree is a collection of rules and rule associations for the scenario. The scenario object 604 sends a request 606 to an entity rule object 608 to determine whether there is anything left to create (e.g., the entity rule object can determine whether the state of the entity is “DONE” or some other state value).

If there is anything left to create, the entity rule object 608 sends a request 610 to a leading node rule 612 associated with a leading node of the entity associated with the entity rule 608. The request 610 is for information associated with the leading node 612. At 614, the leading node rule 612 sends a request 613 to a property rule 614 associated with the leading node 612 to determine a property (e.g., package size, workload portion) associated with the leading node 612.

The package size can correspond, for example, to a workload portion to be generated in parallel in each of multiple data generation tasks. The package size can be selected as or capped at a predefined maximum package size (e.g., 30,000 records). The property rule 614 can determine the package size based on an estimate data volume size for the leading node 612. The property rule 614 can send requests to property rules associated with child nodes associated with the leading node rule 612 to estimate data volume sizes of the child nodes when determining the data volume size for the leading node rule 612. The determination of package sizes can take into account available resources, such as a number of available worker processes, available processors, or number of separate systems which can each be used to generate data.

At 618, the property rule 614 returns the requested property containing a package size to the leading node rule 612. At 620, package size information is sent to the entity rule object 608, as a response to the request 610. The method 600 can be repeated for other entities associated with the scenario 602. The scenario 602 can initiate data generation for each entity, including generating a set of one or more data generation tasks associated with a given entity that can run in parallel to generate data for the given entity.

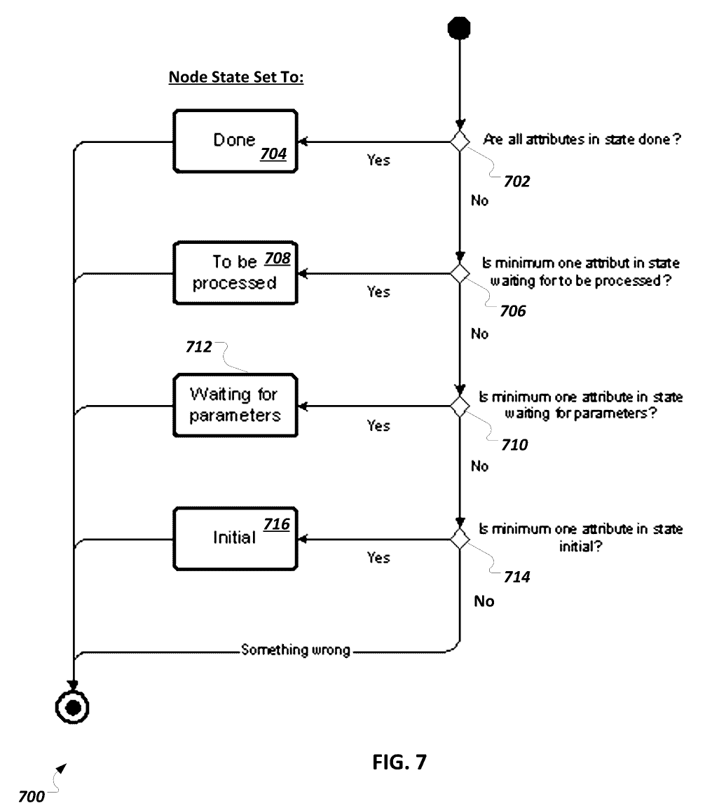

FIG. 7 is a flowchart of an example method 700 illustrating state transitions for a node. It will be understood that method 700 and related methods may be performed, for example, by any suitable system, environment, software, and hardware, or a combination of systems, environments, software, and hardware, as appropriate. For example, one or more of a client, a server, or other computing device can be used to execute method 700 and related methods and obtain any data from the memory of a client, the server, or the other computing device. In some implementations, the method 700 and related methods are executed by one or more components of the system 100 described above with respect to FIG. 1.

In general, the state of a node is based on state values of attributes of the node. At 702, a determination is made as to whether all attributes of the node have an associated state of “Done”. If all attributes of the node have an associated state of “Done”, a state of the node is set to “Done” (e.g., at 704).

If all attributes of the node do not have associated state of “Done”, a determination is made, at 706, as to whether one or more attributes of the node have an associated state of “To Be Processed”. If one or more attributes of the node have an associated state of “To Be Processed”, the state of the node is set to “To Be Processed” (e.g., at 708).

If none of the attributes of the node have an associated state of “To Be Processed”, a determination is made, at 710, as to whether one or more of the attributes of the node have an associated state of “Waiting For Parameters”. If one or more attributes of the node have an associated state of “Waiting For Parameters”, the state of the node is set to “Waiting For Parameters” (e.g., at 712).

If none of the attributes of the node have an associated state of “Waiting For Parameters”, a determination is made, at 714, as to whether one or more of the attributes of the node have an associated state of “Initial”. If one or more attributes of the node have an associated state of “Initial”, the state of the node is set to “Initial” (e.g., at 716). If, at 714, none of the attributes of the node have a state of “Initial”, an error condition can be detected and the state of the node can be set to a value that indicates the error condition.

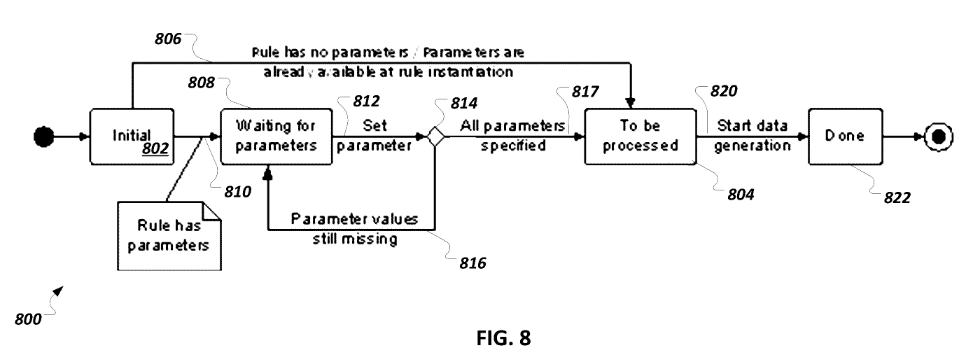

FIG. 8 is a flowchart of an example method 800 illustrating state values and state transition for an attribute rule. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of a client, the server, or the other computing device. In some implementations, the method 800 and related methods are executed by one or more components of the system 100 described above with respect to FIG. 1.

The state of an attribute rule can indicate, for example, whether data generation is enabled (e.g., ready) to be performed or has been performed for the attribute rule. An attribute rule is initially in an initial state 802. In the initial state 802, a determination is made as to whether the attribute rule has associated parameters that are not already available when the instantiation of the attribute rule completes. If the attribute rule has no parameters or if all parameters associated with the attribute rule are available when the instantiation of the attribute rule completes, the state of the attribute rule is set to a “To Be Processed” state 804 (e.g., as illustrated by an arrow 806). Parameters can be available when instantiation completes due to creation of a rule tree that includes, for example, one or more implicit parameter values.

When the attribute rule requires one or more parameter values which are not available at attribute rule instantiation time, the state of the attribute rule is set to a “Waiting For Parameters” state 808 (e.g., as illustrated by an arrow 810). When a parameter value becomes available, the parameter is set to the available parameter value (e.g., as illustrated by an arrow 812). A parameter value can be provided, for example, by a data generator consumer (e.g., a design-time parameter) or by another attribute rule that propagates a data value created by the other attribute rule (e.g., a runtime parameter). For example, a first attribute rule may have logic to calculate a 65^{th} birthday of a customer, including logic to add 65 years to a birthdate value. A birthdate column can be populated by a second attribute rule. The second attribute rule can notify the first attribute rule, which can trigger data generation for the first attribute rule, including use of the generated birthdate values.

After a parameter value is set, a determination is made, at 814, as to whether all parameters have been specified or whether one or more parameter values have not been set. When one or more parameter values have not been set (e.g., as illustrated by an arrow 816), the state of the attribute rule remains at the state “Waiting For Parameters” 808. When all parameter values have been specified (e.g., as illustrated by an arrow 817), the state of the attribute rule is set to the state “To Be Processed” 804.

In the “To Be Processed” state, all parameter values that may exist for the attribute rule are known. The attribute rule can be processed to generate data (e.g., as illustrated by a start generation arrow 820. When data generation completes, the state of the attribute rule is set to a “Done” state 822.

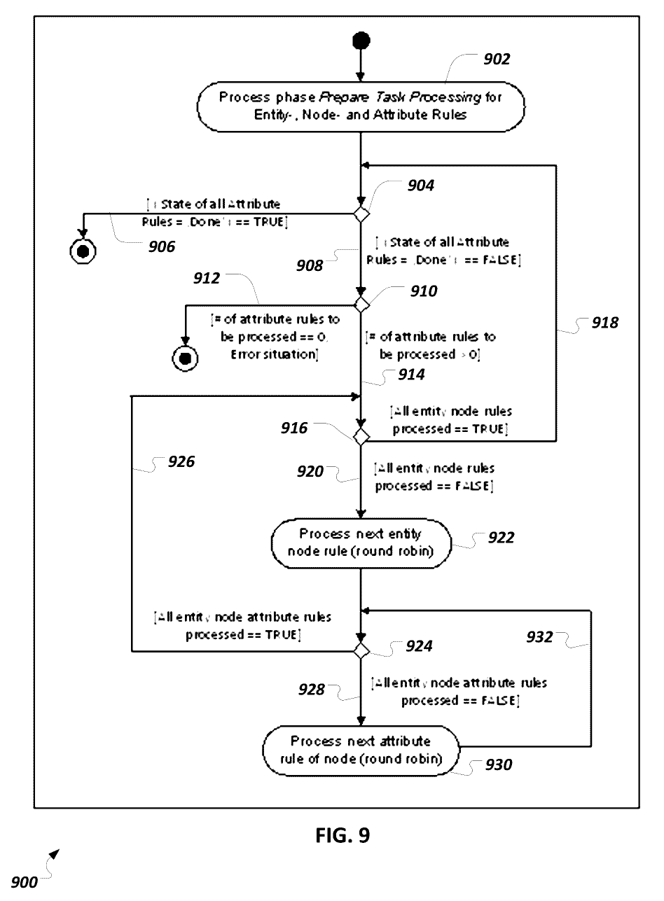

FIG. 9 is a flowchart of an example method 900 for generating data for an entity. It will be understood that method 900 and related methods may be performed, for example, by any suitable system, environment, software, and hardware, or a combination of systems, environments, software, and hardware, as appropriate. For example, one or more of a client, a server, or other computing device can be used to execute method 900 and related methods and obtain any data from the memory of a client, the server, or the other computing device. In some implementations, the method 900 and related methods are executed by one or more components of the system 100 described above with respect to FIG. 1.

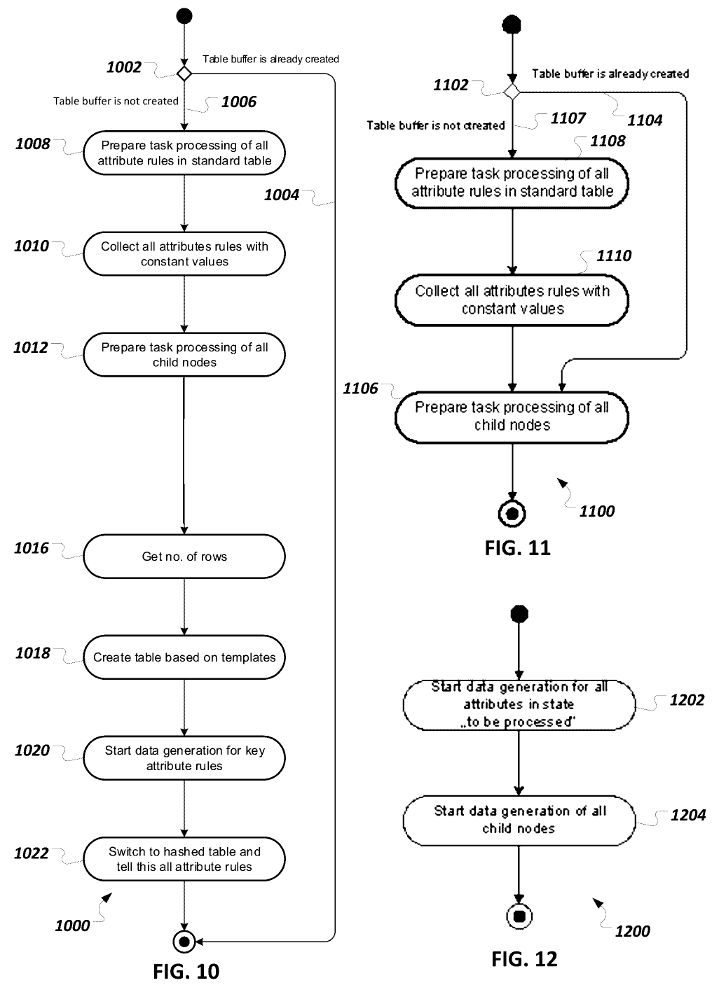

At 902, a prepare-task-processing for entity, node and attribute rules method is performed. For example, the method 1000 described below with respect to FIG. 10 can be performed.

At 904, a determination is made as to whether all attribute rules for a selected node have an associated state value of “Done”. If all attribute rules have an associated state value of “Done” (e.g., as illustrated by an arrow 906), the method 900 ends. If one or more attribute rules have an associated state value other than “Done” (e.g., as illustrated by an arrow 908) then, at 910, a determination is made as to whether the number of attribute rules to be processed (e.g., attribute rules having an associated state of “To Be Processed”) is greater than zero.

If the number of attribute rules to be processed is equal to zero (e.g., as illustrated by an arrow 912), the method 900 ends (e.g., with an error condition). If the number of attribute rules to be processed is greater than zero (e.g., as illustrated by an arrow 914) then, at 916, a determination is made as to whether all entity node rules have been processed. If all entity node rules have been processed (e.g., as illustrated by an arrow 918), then the method 900 resumes at step 904. If all entity node rules have not been processed (e.g., as illustrated by an arrow 920), then processing is performed, at 922, for an identified entity node rule (e.g., a next entity node rule) that has not been processed.

After the next entity node rule has been processed, a determination is made, at 924, as to whether all entity node attribute rules of the identified entity node rule have been processed. If all entity node attribute rules of the identified entity node rule have been processed (e.g., as illustrated by an arrow 926), then the method 900 resumes at 916 to determine whether all entity node rules have been processed (and if not all entity node rules have been processed, then a next unprocessed entity node rule is identified and processed, at 922). If, at 924, a determination is made that not all entity node attribute rules of the identified entity node rule have been processed (e.g., as illustrated by an arrow 928), then, at 930, an unprocessed attribute rule of the node is identified and processed. After the identified attribute rule of the node is processed, then, as illustrated by an arrow 932, the method 900 resumes at 924 to determine whether all entity node attribute rules have been processed for the node.

FIG. 10 is a flowchart of an example method 1000 for preparing task processing for a header node. It will be understood that method 1000 and related methods may be performed, for example, by any suitable system, environment, software, and hardware, or a combination of systems, environments, software, and hardware, as appropriate. For example, one or more of a client, a server, or other computing device can be used to execute method 1000 and related methods and obtain any data from the memory of a client, the server, or the other computing device. In some implementations, the method 1000 and related methods are executed by one or more components of the system 100 described above with respect to FIG. 1.

At 1002, a determination is made as to whether a table buffer has been created for the header node. If a table buffer has been created for the header node (e.g., as illustrated by an arrow 1004), the method 1000 ends. If a table buffer has not been created for the header node (e.g., as illustrated by an arrow 1006) then, at 1008, task processing is prepared for all attribute rules in a standard table.

At 1010, all attribute rules with constant values are collected. At 1012, task processing of all child nodes is prepared (e.g., according to the method 1100 described below with respect to FIG. 11). At 1016, the number of rows to be generated for the header node is determined, such as from a property rule associated with the node. At 1018, a table is created based on one or more templates. At 1020, data generation is initiated for key attribute rules. At 1022, a hash table is generated and associated with each of the attribute rules. A hash key can be a set of table columns that are associated with a node. A hashed table can be used to speed up access to database table buffer rows, e.g. when processing attribute rules that access data in other database table buffer rows.

FIG. 11 is a flowchart of an example method 1100 for preparing task processing for a child node. It will be understood that method 1100 and related methods may be performed, for example, by any suitable system, environment, software, and hardware, or a combination of systems, environments, software, and hardware, as appropriate. For example, one or more of a client, a server, or other computing device can be used to execute method 1100 and related methods and obtain any data from the memory of a client, the server, or the other computing device. In some implementations, the method 1100 and related methods are executed by one or more components of the system 100 described above with respect to FIG. 1.

At 1102, a determination is made as to whether a table buffer has been created for the child node. If a table buffer has been created for the child node (e.g., as illustrated by an arrow 1104), then, at 1106, task processing is prepared for all child nodes that are children of the child node (e.g., recursively, according to the method 1100). If a table buffer has not been created for the child node (e.g., as illustrated by an arrow 1107) then, at 1108, task processing is prepared for all attribute rules of the child node, in a standard table. At 1110, all attribute rules with constant values are collected. At 1106, task processing is prepared for all child nodes that are children of the child node (e.g., recursively, according to the method 1100).

FIG. 12 is a flowchart of an example method 1200 for generating data for a header node. It will be understood that method 1200 and related methods may be performed, for example, by any suitable system, environment, software, and hardware, or a combination of systems, environments, software, and hardware, as appropriate. For example, one or more of a client, a server, or other computing device can be used to execute method 1200 and related methods and obtain any data from the memory of a client, the server, or the other computing device. In some implementations, the method 1200 and related methods are executed by one or more components of the system 100 described above with respect to FIG. 1.

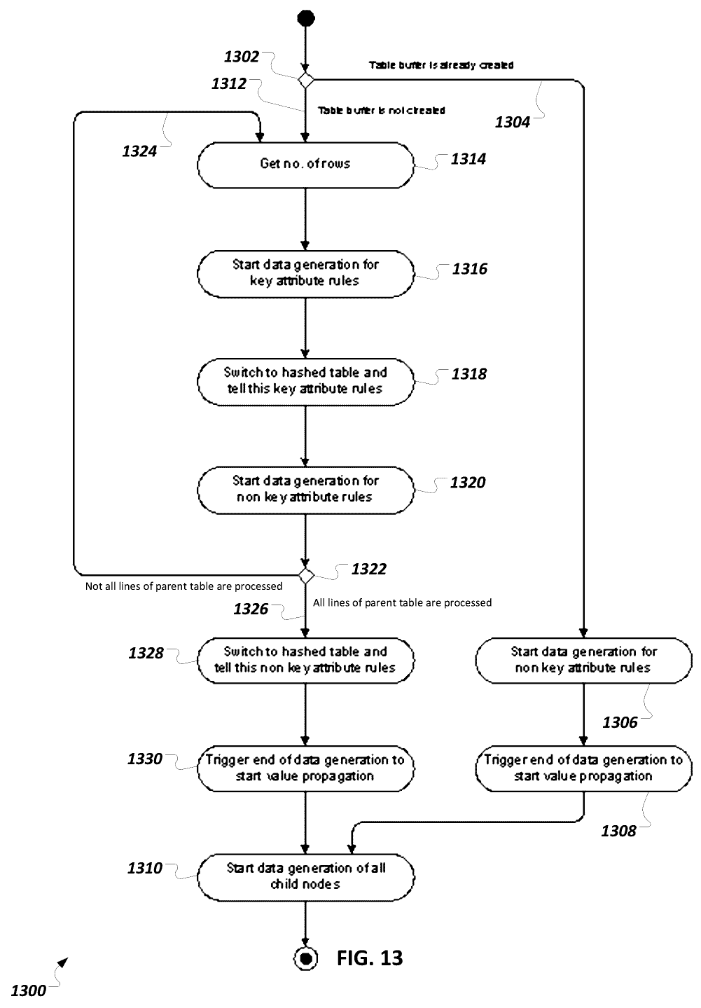

At 1202, data generation is initiated for all attributes of the header node that have an associated state of “To Be Processed”. At 1204, data generation is initiated for all child nodes of the header node (e.g., according to the method 1300 described below with respect to FIG. 13). When methods 1200 and 1300 complete, data generated into table buffers can be copied from memory to one or more data targets.

FIG. 13 is a flowchart of an example method 1300 for generating data for a child node. It will be understood that method 1300 and related methods may be performed, for example, by any suitable system, environment, software, and hardware, or a combination of systems, environments, software, and hardware, as appropriate. For example, one or more of a client, a server, or other computing device can be used to execute method 1300 and related methods and obtain any data from the memory of a client, the server, or the other computing device. In some implementations, the method 1300 and related methods are executed by one or more components of the system 100 described above with respect to FIG. 1.

At 1302, a determination is made as to whether a table buffer has been created for the child node. If a table buffer has been created for the child node (e.g., as illustrated by an arrow 1304), then, at 1306, data generation for non-key attribute rules is initiated. At 1308, an end of data generation event is triggered which can initiate value propagation to dependent attribute rules, for example. At 1310, data generation is initiated for all child nodes that are children of the child node (e.g., recursively, according to the method 1300).

If, at 1302, it is determined that a table buffer has not been created (e.g., as illustrated by an arrow 1312), then, at 1314, a number of rows to generate for the child node is determined (e.g., using a property rule) with respect to a parent node line. At 1316, data generation is initiated for key attribute rules that are associated with the child node. At 1318, a hash table is generated and associated with each of the key attribute rules. At 1320, data generation is initiated for non-key attribute rules that are associated with the child node.

At 1322, a determination is made as to whether all lines of the parent node of the child node have been processed. If not all lines of the parent node have been processed (e.g., as illustrated by an arrow 1324), the method 1300 resumes at 1314. If all lines of the parent node have been processed (e.g., as illustrated by an arrow 1326), then, at 1328, a hash table is generated and associated with each of the non-key attribute rules that are associated with the child node. At 1330, an end of data generation event is triggered which can initiate value propagation to dependent attribute rules, for example.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method comprising:
identifying a data model that describes one or more data entities, each data entity being associated with one or more semantically-related data tables, each data table being associated with one or more data attributes;
evaluating the data model to determine a set of entity dependencies between entities and, for each entity, a set of data table dependencies between data tables of the entity;
identifying a set of rules for a data generation scenario for generation of data for the one or more data entities, the set of rules including one or more data target rules specifying at least one data target for storing the generated data, one or more quantity rules which indicate how much data to generate, and one or more attribute rules each describing how data for one or more data attributes is to be generated;
determining a set of workload portions based on the one or more quantity rules and the determined entity dependencies and data table dependencies;
generating data according to the set of attribute rules, the entity dependencies, and the data table dependencies, including creating a data generation task for each determined workload portion; and
storing data generated from each data generation task in the at least one data target.

2. The method of claim 1, further comprising receiving at least one parameter for at least one rule.

3. The method of claim 1, wherein determining the set of workload portions comprises determining whether data corresponding to one or more rules already exists in a data target.

4. The method of claim 1, wherein evaluating the data model to determine entity dependencies comprises identifying a first entity and a second entity that is dependent on the first entity; and wherein generating data comprises generating data for the first entity before generating data for the second entity.

5. The method of claim 4, wherein the first entity comprises master data and the second entity comprises transactional data.

6. The method of claim 4, wherein evaluating the data model comprises identifying a parent data table associated with the first entity and a child data table associated with the first entity; and wherein generating data for the first entity comprises generating data for the parent data table before generating data for the child data table.

7. The method of claim 1, further comprising evaluating the data model and the attribute rules to determine dependencies between attributes, including identifying a first attribute that is dependent upon a second attribute; wherein generating data comprises generating data for the second attribute before generating data for the first attribute.

8. The method of claim 7, wherein the first attribute and the second attribute are associated with the same data table.

9. The method of claim 7, wherein the first attribute and the second attribute are associated with different data tables.

10. The method of claim 1, wherein identifying the set of rules comprises identifying at least one predetermined rule previously used for at least one other data generation scenario.

11. The method of claim 1, wherein identifying the set of rules comprises generating at least one rule that has not been used for another data generation scenario.

12. The method of claim 1, wherein determining the set of workload portions comprises:
identifying at least two candidate workload calculation algorithms;
identifying a set of resources available for data generation;
selecting a particular candidate workload calculation algorithm based on the available resources; and
determining the set of workload portions based on the selected workload calculation algorithm.

13. A system comprising:
one or more computers associated with an enterprise portal; and
a computer-readable medium coupled to the one or more computers having instructions stored thereon which, when executed by the one or more computers, cause the one or more computers to perform operations comprising:
identifying a data model that describes one or more data entities, each data entity being associated with one or more semantically-related data tables, each data table being associated with one or more data attributes;
evaluating the data model to determine a set of entity dependencies between entities and, for each entity, a set of data table dependencies between data tables of the entity;
identifying a set of rules for a data generation scenario for generation of data for the one or more data entities, the set of rules including one or more data target rules specifying at least one data target for storing the generated data, one or more quantity rules which indicate how much data to generate, and one or more attribute rules each describing how data for one or more data attributes is to be generated;
determining a set of workload portions based on the one or more quantity rules and the determined entity dependencies and data table dependencies;
generating data according to the set of attribute rules, the entity dependencies, and the data table dependencies, including creating a data generation task for each determined workload portion; and
storing data generated from each data generation task in the at least one data target.

14. The system of claim 13, the operations further comprising receiving at least one parameter for at least one rule.

15. The system of claim 13, wherein determining the set of workload portions comprises determining whether data corresponding to one or more rules already exists in a data target.

16. The system of claim 13, wherein evaluating the data model to determine entity dependencies comprises identifying a first entity and a second entity that is dependent on the first entity; and wherein generating data comprises generating data for the first entity before generating data for the second entity.

17. A computer program product encoded on a non-transitory storage medium, the product comprising non-transitory, computer readable instructions for causing one or more processors to perform operations comprising:
identifying a data model that describes one or more data entities, each data entity being associated with one or more semantically-related data tables, each data table being associated with one or more data attributes;
evaluating the data model to determine a set of entity dependencies between entities and, for each entity, a set of data table dependencies between data tables of the entity;
identifying a set of rules for a data generation scenario for generation of data for the one or more data entities, the set of rules including one or more data target rules specifying at least one data target for storing the generated data, one or more quantity rules which indicate how much data to generate, and one or more attribute rules each describing how data for one or more data attributes is to be generated;
determining a set of workload portions based on the one or more quantity rules and the determined entity dependencies and data table dependencies;
generating data according to the set of attribute rules, the entity dependencies, and the data table dependencies, including creating a data generation task for each determined workload portion; and
storing data generated from each data generation task in the at least one data target.

18. The product of claim 17, the operations further comprising receiving at least one parameter for at least one rule.

19. The product of claim 17, wherein determining the set of workload portions comprises determining whether data corresponding to one or more rules already exists in a data target.

20. The product of claim 17, wherein evaluating the data model to determine entity dependencies comprises identifying a first entity and a second entity that is dependent on the first entity; and wherein generating data comprises generating data for the first entity before generating data for the second entity.
